(19) United States
(12) Patent Application Publication
(10) Pub. No.: US 2014/0134582 A1
(43) Pub. Date: May 15, 2014

(54) ACTION MOTIVATION DEVICE, ACTION MOTIVATION METHOD, AND RECORDING MEDIUM

(71) Applicants: Taku Konishi, Tokyo (JP); Shinichi Doi, Tokyo (JP); Satoko Itaya, Tokyo (JP); Rie Tanaka, Tokyo (JP); Naoki Yoshinaga, Tokyo (JP)

(72) Inventors: Taku Konishi, Tokyo (JP); Shinichi Doi, Tokyo (JP); Satoko Itaya, Tokyo (JP); Rie Tanaka, Tokyo (JP); Naoki Yoshinaga, Tokyo (JP)

(21) Appl. No.: 14/232,199

(22) PCT Filed: Jul. 11, 2012
(86) PCT No.: PCT/JP2012/067751

§ 371 Date: Jan. 10, 2014

(30) Foreign Application Priority Data
Jul. 11, 2011 (JP) 2011-153249

(51) Int. Cl. G09B 5/02

(52) U.S. Cl. CPC G09B 5/02
USPC 434/236

(57) ABSTRACT

An activity information obtainer (11) obtains activity information indicating an activity of a user detected by an activity detector (21), and stores it in an activity information memory (12). A parameter selector (13) selects a parameter value within a predetermined range for each of multiple activity parameters indicating barometers of activities of the user from the activity information stored in the activity information memory (12), and selects a specific activity parameter based on the distribution of the selected parameter values and a predetermined selection condition. A position calculator (14) calculates a position of a target user relative to other users with respect to the specific activity parameter selected by the parameter selector (13). A presentation information generator (15) generates presentation information indicating the position of the target user, and transmits it to an outputter (22). The outputter (22) outputs the presentation information.

### TECHNICAL FIELD

The present invention relates to an action motivation device, an action motivation method, and a recording medium that motivate an action of a user.

### BACKGROUND ART

An example method of motivating a person to take a particular action (of prompting a person to take a particular action further willingly) is a method of presenting a status of an action by another person who is taking the same action.

For example, Patent Literature 1 discloses a system that presents a status of a diet activity by another person with a similar set goal to a person on a diet with a set goal.

In addition, Patent Literature 2 discloses a system that presents, to a user who is studying using a given learning material, a study record of another person utilizing the same learning material.

Patent Literature 3 discloses an action motivation system that presents a position of a user among all of the users with respect to a status of a given activity to that user, thereby motivating the user to take an action.

In order to motivate a person to take an action upon being presented with a status of the action of another person, it is effective to present an activity of another person with similar level and accomplishment to the activity of a user (hereinafter, referred to as a target user) to be motivated to take an action. That is, by presenting information on the status of another user with similar activity level and accomplishment to the target user so as to let the target user to think that such a user can catch up with someone if such a user makes an effort a little bit more or that such a user is overtaken by someone else if such a user takes a second best, thereby inducing a competition. This is expected to activate the activities.

However, according to the systems disclosed in Patent Literatures 1 to 3, there is only one reference to select another user subjected to the presentation of the status of an activity and a result. Accordingly, it is sometimes difficult to present appropriate information on another user. For example, with reference to a selection reference, when there is no another user having a similar value to the value (a target value, a learning time period, a position) of the target user, it is unable to provide information on another user. In addition, when there is presentation information appropriate for a presentation, it is difficult to present such information.

### CITATION LIST

### Patent Literature

Patent Literature 1: Unexamined Japanese Patent Application Kokai Publication No. 2001-331585

Patent Literature 2: Unexamined Japanese Patent Application Kokai Publication No. 2003-162209

Patent Literature 3: Unexamined Japanese Patent Application Kokai Publication No. 2010-204883

### SUMMARY OF INVENTION

### Technical Problem

The present invention has been made in view of the foregoing circumstances, and it is an objective of the present invention to provide an action motivation device, an action motivation method, and a recording medium that present appropriate information on a status of an activity of another person.

Moreover, it is another objective of the present invention to provide an action motivation device, an action motivation method, and a recording medium that can motivate a user to take an action further effectively.

### Solution to Problem

An action motivation device according to a first aspect of the present invention includes: an obtainer that obtains activity information indicating respective activities of a plurality of users; a memory that stores the activity information obtained by the obtainer; a selector that selects, based on the activity information stored in the memory, a parameter value within a predetermined range for each of a plurality of activity parameters which are barometers of the activity of the user, and selects a specific activity parameter based on a distribution of selected parameter values and a predetermined selection condition; a position calculator that calculates a position of a target user relative to other users with respect to the specific activity parameter selected by the selector; a generator that generates presentation information indicating the position of the target user; and a presenter that presents the presentation information to the target user.

An action motivation method according to a second aspect of the present invention is executed by an action motivation device that motivates a target user to take an action, the method including: an obtaining step of obtaining activity information indicating respective activities of a plurality of users; a memory step of storing the activity information obtained through the obtaining step in a memory; a selecting step of selecting, based on the activity information stored in the memory, a parameter value within a predetermined range for each of a plurality of activity parameters which are barometers of the activity of the user, and selecting a specific activity parameter based on a distribution of selected parameter values and a predetermined selection condition; a position calculating step of calculating a position of the target user relative to the other users with respect to the specific activity parameter selected through the selecting step; a generating step of generating presentation information indicating the position of the target user; and a presenting step for presenting the presentation information to the target user.

A computer-readable recording medium according to a third aspect of the present invention has stored therein a program that causes a computer to function as: an obtainer that obtains activity information indicating respective activities of a plurality of users; a memory that stores the activity information obtained by the obtainer; a selector that selects, based on the activity information stored in the memory, a parameter value within a predetermined range for each of a plurality of activity parameters which are barometers of the activity of the user, and selects a specific activity parameter based on a distribution of selected parameter values and a predetermined selection condition; a position calculator that calculates a position of a target user relative to other users with respect to the specific activity parameter selected by the selector; a generator that generates presentation information indicating the position of the target user; and a presenter that presents the presentation information to the target user.

### Advantageous Effects of Invention

According to the present invention, it becomes possible to provide information on another user with similar activity level and accomplishment to a target user, and to motivate the target user to take an action.

### BRIEF DESCRIPTION OF DRAWINGS

FIG. 1 is a block diagram illustrating a system configuration of an action motivation system according to an embodiment;

FIG. 2 is a block diagram illustrating a parameter selector in the action motivation system in FIG. 1;

FIG. 3A is a flowchart for explaining an action motivating operation by the action motivation system illustrated in FIG. 1;

FIG. 3B is a flowchart for explaining an action motivating operation by the action motivation system illustrated in FIG. 1;

FIG. 4 is a diagram illustrating an extraction range set by the parameter selector in FIG. 1;

FIG. 5A is a diagram for explaining a user density;

FIG. 5B is a diagram for explaining the user density;

FIG. 6 is a diagram illustrating a user density of each activity parameter calculated by the parameter selector in FIG. 1;

FIG. 7 is a diagram illustrating example presentation information by the action motivation system illustrated in FIG. 1 based on a user density;

FIG. 8 is a diagram illustrating an example user similarity of each activity parameter calculated by the parameter selector in FIG. 1;

FIG. 9 is a diagram illustrating example presentation information by the action motivation system in FIG. 1 based on a user similarity; and

FIG. 10 is a block diagram illustrating a hardware configuration of an action motivation device illustrated in FIG. 1.

### DESCRIPTION OF EMBODIMENTS

A detailed explanation will be given of an action motivation system according to an embodiment with reference to the accompanying drawings. Note that the same or corresponding portion will be denoted by the same reference numeral.

An action motivation system 100 of this embodiment includes an action motivation device 1, a terminal device 2A, and a terminal device 2B. The action motivation device 1, the terminal device 2A, and the terminal device 2B mutually communicate one another through a communication network. The terminal device 2A and/or the terminal device 2B may be possessed for each user, or may be placed at a predetermined location, and shared by multiple users.

The action motivation device 1 includes an activity information obtainer 11, an activity information memory 12, a parameter selector 13, a position calculator 14, and a presentation information generator 15. The terminal device 2A includes an activity detector 21, and the terminal device 2B includes an outputter 22.

The activity detector 21 of the terminal device 2A detects an activity by a user, and digitalizes various parameters representing a status of the activity, and a result and accomplishment thereof. Next, the activity detector 21 associates the digitalized user's activity with identification information for identifying the user, a date at which the activity of the user is detected, and the like, and transmits those pieces of data as activity information to the action motivation device 1.

More specifically, the activity detector 21 obtains values of various parameters representing the status of a user's particular activity, a result and an accomplishment, and the like, adds the identification information, the date, and the like to the obtained parameter value to generate the activity information, and transmits the generated activity information to the action motivation device 1.

For example, when the “activity” is dieting, the activity detector 21 detects (obtains) values of various parameters representing the “status” and “accomplishment” of the “activity=dieting”, such as activity parameters “weight”, “height”, “body fat percentage”, “three sizes”, and “accomplishment level”, and generates the activity information including the obtained values.

Moreover, when the “activity” is studying, the activity detector 21 obtains values of parameters representing the status, and the result and accomplishment of the activity (=studying), and the like, such as activity parameters “learning hours”, “progress level”, “accomplishment level”, “test score”, and “deviation score”, and generates the activity information including the obtained parameter values.

Detection of the user's activity is performed as follow.

For example, the activity detector 21 includes a weight scale or a body fat scale that includes a tag reader that reads an RF (Radio Frequency) tag of the user, and a timer. In this case, the activity detector 21 reads the RF tag of the user to obtain identification information on the user, reads year, month, day, and clock time from the timer, further measures a weight or a body fat percentage, generates the activity information including those pieces of information, and transmits the activity information to the action motivation device 1.

Moreover, for example, the activity detector 21 is held by each user, and includes a GPS (Global Positioning System) receiver. The activity detector 21 determines that the user is “studying” when, for example, the position measured by the GPS receiver is located in a study room registered in advance, measures, for example, a time period, adds the user identification information and the clock time to the measured time to generate the activity information, and transmits the activity information to the action motivation device 1.

Still further, for example, the activity detector 21 includes a GPS receiver and a camera disposed in a predetermined room. When the activity detector 21 senses that the user enters a predetermined range upon detection by the GPS receiver, the camera picks up an image of the user or that location, and the user generates image data. An acceleration sensor of the terminal device held by the user or an acceleration sensor disposed at the predetermined location detects an acceleration, and generates information indicating a motion of the user. The activity detector 21 analyses such information, and detects that the user starts an exercise at the predetermined location.

Alternatively, a consumed power meter is provided at a house of the user, and detects the consumed power by an electric appliance to detect that the electric appliance is in use. Or, GPS information is obtained from a portable terminal held by the user to detect that the user is moving. When it is detected that the user is moving, it is appropriate if means of mobility (for example, a vehicle, a train or by walk) is identified based on a moving speed, an acceleration, map information, and the like. The activity information may be input into the terminal device 2A by the user.

The activity information obtainer 11 of the action motivation device 1 receives the activity information from the terminal device 2A. The activity information obtainer 11 stores the received activity information in the activity information memory 12.

The parameter selector 13 extracts one or multiple activity information (hereinafter, referred to as an activity information set) containing an activity parameter with a value that is within an extraction range with reference to a value of each activity parameter included in the activity information of the target user stored in the activity information memory 12. In addition, the parameter selector 13 calculates, for each activity parameter, a user density that indicates a variance of the value of each activity parameter in the extracted activity information set, and a user similarity that indicates a similarity of the parameter value of another user to the parameter value of the target user. The parameter selector 13 selects a specific activity parameter (hereinafter, referred to as a presentation activity parameter) utilized for generating presentation information to be presented to the target user based on the calculated user density and/or user similarity. The detail of the selecting method of the presentation activity parameter will be explained later. The parameter selector 13 transmits the activity information set of the presentation activity parameter to the position calculator 14.

The position calculator 14 calculates, with respect to the activity information set of the presentation activity parameter received from the parameter selector 13, the position of the target user relative to another user in the presentation activity parameter. The position calculator 14 transmits position information indicating the calculated position of the target user to the presentation information generator 15.

With respect to the presentation activity parameter, the position calculator 14 may set a new extraction range different from the extraction range set by the parameter selector 13 with reference to the value of each parameter of the activity information of the target user, and may newly extract the activity information set included in this extraction range from the activity information memory 12. In this case, the parameter selector 13 transmits information indicating the presentation activity parameter to the position calculator 14. The position calculator 14 calculates, with respect to the activity information set of the presentation activity parameter newly extracted, the position of the target user relative to another user in the presentation activity parameter.

The presentation information generator 15 generates presentation information indicating the position of the target user (the relative position in the set of the values of the presentation target parameter included in the activity information set of the value of the presentation target parameter of the target user) based on the position information received from the position calculator 14. The presentation information is an image displaying the position of the target user or a notification message of notifying the target user of the position. The presentation information generator 15 transmits the generated presentation information to the terminal device 2B.

The outputter 22 of the terminal device 2B outputs the presentation information received from the action motivation device 1. When the presentation information is an image, the outputter 22 displays such an image. When the presentation information is a notification message, the outputter 22 may display such a notification message on the screen or may output via voice.

The terminal device 2A and the terminal device 2B may be a single terminal including the activity detector 21 and the outputter 22. Alternatively, the action motivation device 1 may have the activity detector 21 and the outputter 22.

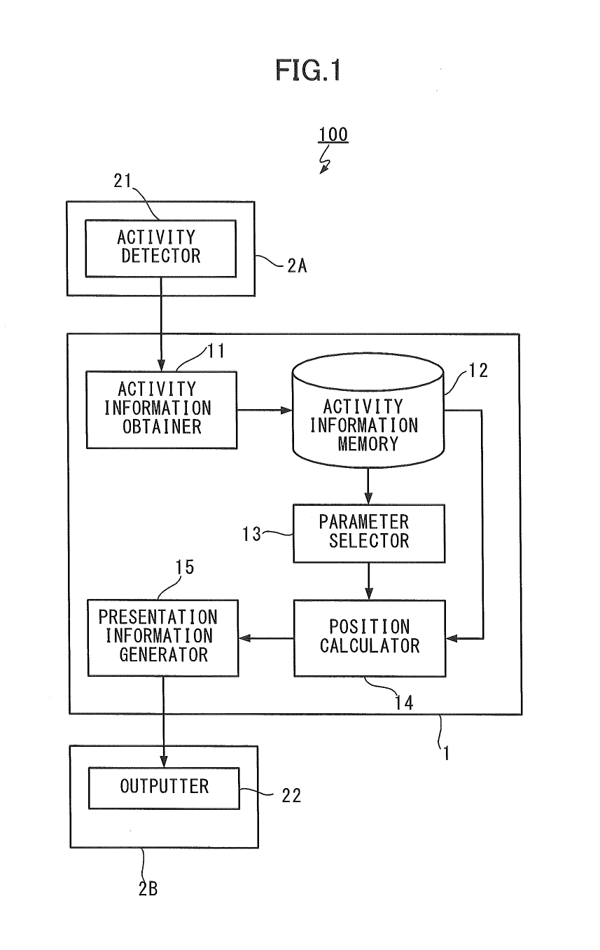

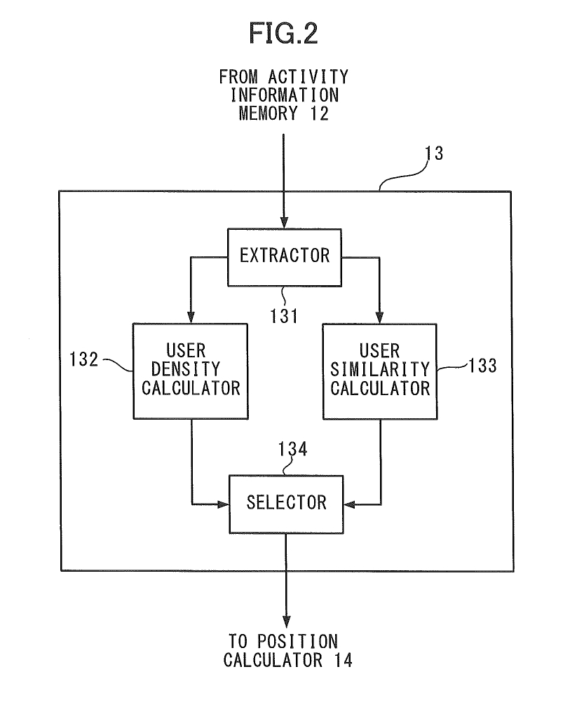

FIG. 2 is a block diagram illustrating an example configuration of the parameter selector 13 in FIG. 1. The parameter selector 13 includes an extractor 131, a user density calculator 132, a user similarity calculator 133, and a selector 134.

The extractor 131 reads activity information of the target user stored in the activity information memory 12, and calculates values of multiple activity parameters set in advance from the read activity information. When the activity information contains parameters, those parameters may be directly utilized. When the activity information only indicates that the target user is exercising, and includes data on a speed and a pulse rate, a parameter that is an exercise quantity may be calculated. The extractor 131 sets an extraction range for each activity parameter with reference to the value of each calculated activity parameter. The extractor 131 extracts the activity information set contained in the extraction range of each activity parameter from the activity information memory 12.

The user density calculator 132 calculates, for each activity parameter, each user density that indicates a variance (hereinafter, referred to as a user variance) of the value of the activity parameter extracted by the extractor 131. The detail of the user density will be explained later.

The user similarity calculator 133 calculates, with respect to each activity parameter extracted by the extractor 131, a user similarity indicating a level (difference: a distance) of similarity between the parameter value of another user and the parameter value of the target user. The detail of the user similarity will be explained later.

The selector 134 selects, based on the user density and/or user similarity calculated by the user density calculator 132 and the user similarity calculator 133, respectively, a presentation activity parameter used for generating the presentation information to be presented to the target user. The selector 134 transmits the activity information set extracted for the presentation activity parameter to the position calculator 14.

The parameter selector 13 may employ a configuration including only either one of the user density calculator 132 and the user similarity calculator 133.

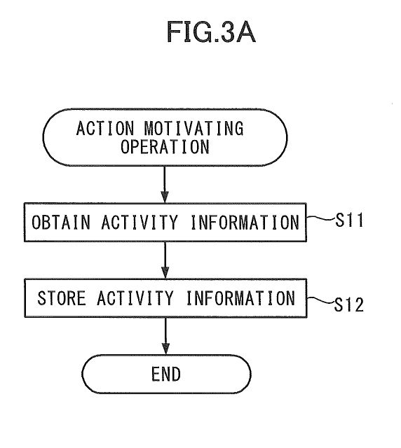

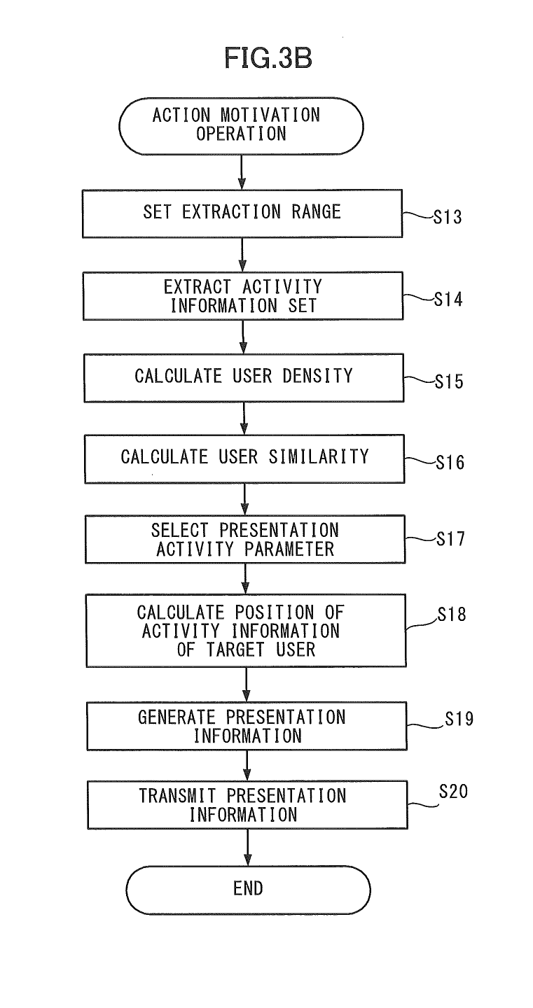

FIG. 3A and FIG. 3B are flowcharts illustrating an operation of the action motivation system illustrated in FIG. 1. When detecting an activity of the user, the activity detector 21 of the terminal device 2A digitalizes this activity. Next, the activity detector 21 associates the digitalized activity with the identification information for identifying the user, and the date at which the user's activity is detected, and transmits those pieces of information as the activity information to the activity information obtainer 11 of the action motivation device 1.

As illustrated in FIG. 3A, the activity information obtainer 11 obtains the activity information from the activity detector 21 (step S11). The activity information memory 12 stores therein the activity information obtained by the activity information obtainer 11 (step S12).

For example, the above-explained operations are repeatedly performed at a predetermined cycle or every time the activity information is generated.

Conversely, the action motivation device 1 specifies the target user, and executes a process illustrated in FIG. 3B.

First, the extractor 131 of the parameter selector 13 sets the extraction range for each activity parameter with reference to the value of each activity parameter in the activity information of the target user (step S13). The extractor 131 extracts, from the activity information memory 12, the activity information set containing the activity pattern with the value included in the extraction range of each activity parameter (step S14).

The user density calculator 132 of the parameter selector 13 calculates the user density indicating a user variance in the activity information set extracted by the extractor 131 for each activity parameter (step S15). The user similarity calculator 133 of the parameter selector 13 calculates the user similarity indicating the level of similarity of another user to the target user in the activity information set extracted by the extractor 131 for each activity parameter (step S16).

The selector 134 of the parameter selector 13 selects, based on the user density and/or the user similarity calculated by the user density calculator 132 and the user similarity calculator 133, respectively, a presentation activity parameter used for generating presentation information to be presented to the target user (step S17).

The position calculator 14 calculates the position of the target user relative to another user in the presentation activity parameter for the activity information set contained in the extraction range of the presentation activity parameter (step S18).

The presentation information generator 15 generates the presentation information indicating the position of the target user calculated by the position calculator 14 (step S19). The presentation information generator 15 transmits the generated presentation information to the terminal device 2B (step S20), and terminates the process. The outputter 22 of the terminal device 2B outputs the presentation information received from the action motivation device 1.

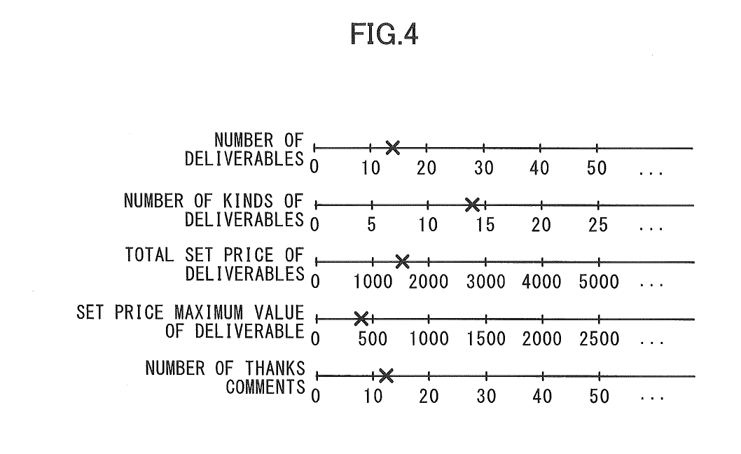

A specific explanation will be given of a method of selecting a specific activity parameter by the parameter selector 13 with reference to FIGS. 4 to 9 and the flowcharts of FIG. 3A and FIG. 3B.

In the example case illustrated in FIGS. 4 to 9, a recycling activity is presumed which lends a private possession and sells a used item through a Web page. Those private possession and used item are hereinafter referred to as deliverables. A user registers the deliverable on the Web page. Next, the user gives the deliverable obtaining an offer through the Web page to the offerer. A person who received the deliverable can enter a recognition comment to the supplier (user) on the Web page. This comment is hereinafter referred to as a thanks comment. An activity to be motivated is lending of the private possession and providing of the used item for sale (registration of the deliverable on the Web page).

FIG. 4 is a diagram illustrating an extraction range set by the parameter selector 13 in FIG. 1. The extractor 131 of the parameter selector 13 stores in advance multiple process-target activity parameters that are “number of deliverables”, “number of kinds of deliverables”, “total set price of deliverables”, “set price maximum value of deliverable” and “number of thanks comments”. The extractor 131 reads the activity information of the target user within a predetermined time period (in this example, one month) from the activity information stored in the activity information memory 12.

The extractor 131 calculates the value of each activity parameter from the read activity information of the target user. The extractor 131 sets the extraction range with reference to the calculated value (step S13).

In the example case illustrated in FIG. 4, the “number of deliverables” of the target user in a month is 14, the “number of kinds of deliverables” is 13, the “total set price of deliverables” is JP 1500 YEN, the “set price maximum value of deliverable” is JP 400 YEN, and the “number of thanks comments” is 12. As illustrated in FIG. 4, the value of each activity parameter is segmented by a predefined unit. The extractor 131 sets a segment including the value of the activity parameter of the activity information of the target user (indicated by a cross mark in the figure) as an extraction range. In FIG. 4, the extraction range of the “number of deliverables” is from 10 to 20 (deliverables), the extraction range of the “number of kinds of deliverables” is from 10 to 15 (kinds), the extraction range of the “total set price of deliverables” is from JP 1000 to 2000 (YEN), the extraction range of the “set price maximum value of deliverable” is from JP 0 to 500 (YEN), and the extraction range of the “number of thanks comments” is from JP 10 to 20 (numbers).

Each activity parameter may be normalized in advance. In addition, the extraction range is not limited to the one obtained with reference to the calculated value by the extractor 131. For example, with reference to the average value of the activity parameters contained in the activity information of the target user, a predetermined range may be set as an extraction range. Alternatively, with respect to a range (full range) from the minimum value to the maximum value of each activity parameter of all pieces of activity information stored in the activity information memory 12, a range at the same ratio may be set as an extraction range. In this case, the extractor 131 specifies, with respect to each activity parameter, the maximum value and the minimum value in the values of the activity parameters contained in all pieces of activity information, and normalizes those. Next, a range at the same ratio (for example, 1/10 of the range from the minimum value to the maximum value) relative to the full range and including the value of the activity parameter of the activity information of the target user is set as an extraction range. Accordingly, it becomes possible to reduce a possibility that, when the value of the activity parameter of the activity information of the target user is an outlier in the whole distribution, the selector 134 selects this activity parameter as a presentation activity parameter.

The extractor 131 extracts, for each activity parameter, the activity information set having the activity parameter value within the extraction range among the activity information stored in the activity information memory 12 (step S14).

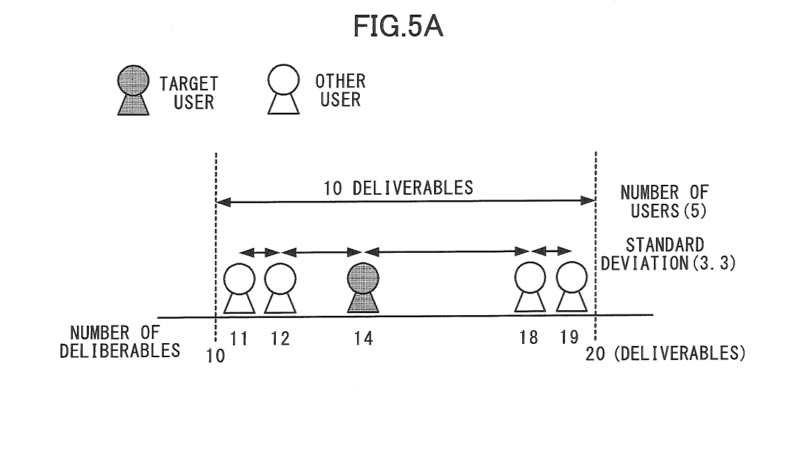

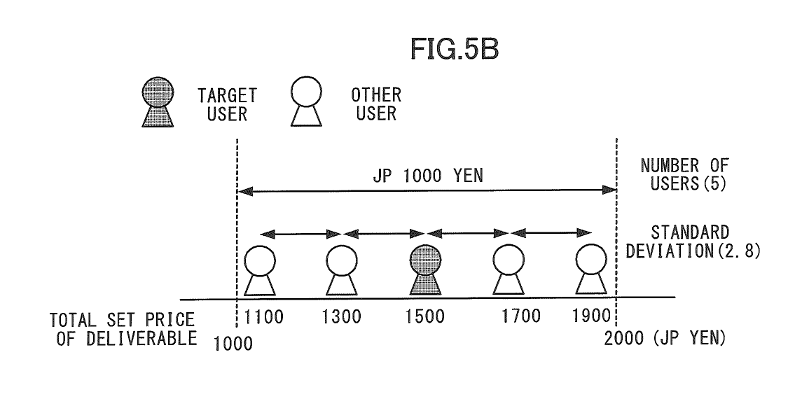

FIGS. 5A and 5B are diagrams for explaining the user density of the activity parameter “number of deliverables” and the user density of the activity parameter “total set price of deliverable”, respectively. The user density calculator 132 calculates the user density from the activity information set extracted from the extractor 131 for each activity parameter (step S15). In this example, the number of users in the activity information set and the standard deviation for each activity parameter extracted by the extractor 131 are calculated as the user density.

The user density is not limited to this example, and can be the number of users only, or the standard deviation only. Alternatively, the user density may be other barometers like a quartile deviation.

It is presumed that there are five users corresponding to the activity information set containing the parameter values of the extraction range from 10 to 20 (deliverables) of the activity parameter “number of deliverables”. In addition, it is presumed that the respective numbers of deliverables are 11, 12, 14, 18, and 19. The user density calculator 132 calculates single digit numbers that are 1, 2, 4, 8, and 9 obtained by subtracting the lower limit number 10 of the extraction range from the respective numbers of the deliverables, and calculates a standard deviation 3.2 (round off two decimal places) of those numbers.

Likewise, it is presumed that there are five users corresponding to the activity information set containing the parameter values of the extraction range from JP 1000 to 2000 (YEN) of the activity parameter “total set price of deliverable”. In addition, it is presumed that respective total set prices of deliverables are JP 1100 YEN, 1300 YEN, 1500 YEN, 1700 YEN, and 1900 YEN. The user density calculator 132 calculates numbers that are 1, 3, 5, 7, and 9 obtained by dividing the numbers 100, 300, 500, 700, and 900, obtained by subtracting the lower limit number 1000 of the extraction range from the respective numbers of deliverables, by 100 to line up the number of digits to a single digit, and calculates a standard deviation 2.8 (round off two decimal places) of those numbers.

As illustrated in FIGS. 5A and 5B, the activity parameter “total set price of deliverable” with a smaller value of the user density (standard deviation) has a shorter interval between another user and the target user. Hence, if information thereof is presented, the competitive consciousness of the target user can be induced, and thus it is expected that the activity is activated. Hence, the selector 134 selects, as the presentation activity parameter, the activity parameter having the smallest user density value rather than the user density value (standard deviation) that is zero.

As explained above, when the extractor 131 extracts the activity information set with a predetermined range from the average value of the respective activity parameters of the target user being as an extraction range, a standard deviation around the target user can be obtained, which is further suitable.

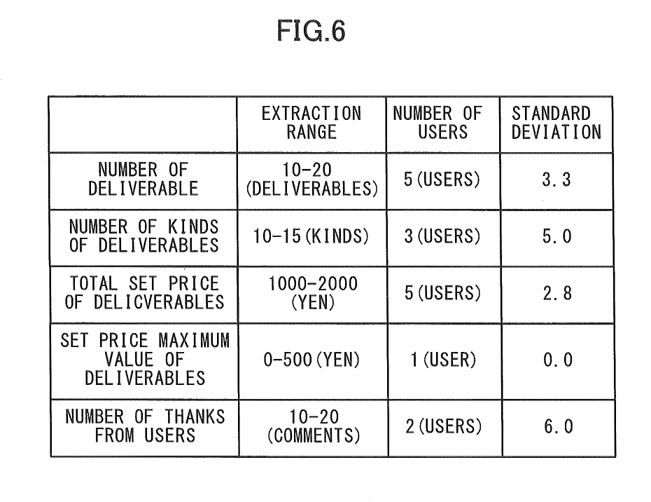

The user density calculator 132 calculates the user density for each activity parameter as explained above, and generates data illustrated in FIG. 6.

FIG. 6 is a diagram illustrating an example user density of each activity parameter calculated by the parameter selector 13 in FIG. 1. According to the example case illustrated in FIG. 6, the number of users in the extraction range of the “number of deliverables” from 10 to 20 (deliverables) is five, and the standard deviation is 3.3, the number of users in the extraction range of the “number of kinds of deliverables” from 10 to 15 (kinds) is three, and the standard deviation is 5.0, the number of users in the extraction range of the “total set price of deliverable” from JP 1000 to 2000 (YEN) is five, and the standard deviation is 2.8, the number of users in the extraction range of the “set price maximum value of deliverable” from JP 0 to 500 (YEN) is one, and the standard deviation is 0.0, and, the number of users in the extraction range of the “number of thanks comments” from 10 to 20 (comments) is two, and the standard deviation is 6.0. The selector 134 selects the activity parameter “total set price of deliverable” with the smallest standard deviation value rather than the standard deviation that is zero among those activity parameters (step 817). Next, the selector 134 transmits the presentation activity parameter of the activity information set to the position calculator 14.

The condition of selecting the presentation activity parameter by the selector 134 is not limited to the one having the smallest standard deviation value rather than zero, but may be one having the largest number of users, or may be a combination of conditions such that the number of users is equal to or greater than a predetermined number, and, the standard deviation is the smallest.

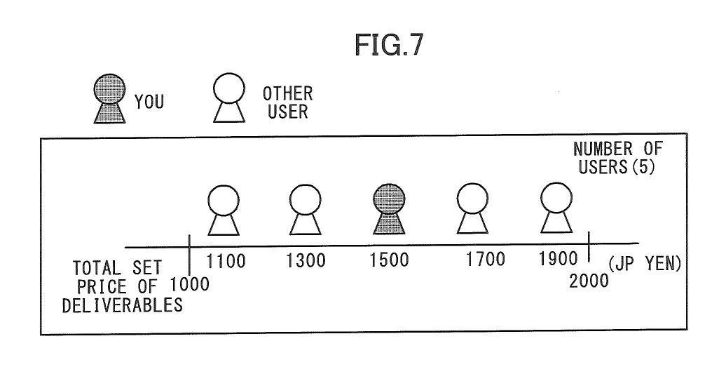

FIG. 7 is a diagram illustrating example presentation information based on the user density of the action motivation system in FIG. 1. The position calculator 14 calculates, with respect to the activity information set of the presentation activity parameter “total set price of deliverables, the position of the value of the “total set price of deliverables” of the target user relative to the value of the “total set price of deliverables” of other users. The position calculator 14 transmits positional information indicating the calculated position of the target user to the presentation information generator 15. The positional information is, for example, information obtained by associating the value of the presentation activity parameter of the activity information of the target user, the value of the presentation activity parameter of each activity information forming the activity information set, and information indicating the extraction range with each other. The presentation information generator 15 generates presentation information illustrated in FIG. 7 based on the positional information received from the position calculator 14.

In FIG. 7, the target user and other users within the extraction range from JP 1000 to 2000 (YEN) of the presentation activity parameter “total set price of deliverables” are indicated by symbols and different colors. Hence, it becomes possible from the target user to understand the positional relationship with the other users. In this case, a notification message to the effect that, for example, “there are four users similar to the value of your total set price of deliverables” or “there is a user with a total set price of deliverables JP 200 YEN higher than your total set price of deliverables and also a user with a total set price of deliverables JP 200 YEN lower than your total set price of deliverables” may be added to the presentation information.

The positional information may be information obtained by associating information indicating the number of users within the extraction range, information indicating the rank of the target user or a difference from the closest other user, and information indicating the extraction range. In addition, the presentation information may be a display image for displaying those pieces of information or a notification message.

Next, an explanation will be given of the user similarity calculated by the user similarity calculator 133 of the parameter selector 13.

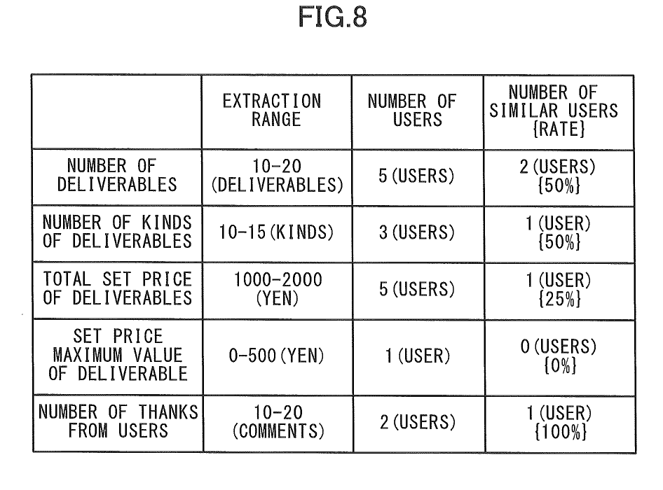

FIG. 8 is a diagram illustrating the user similarity of each activity parameter calculated by the parameter selector 13 in FIG. 1. The user similarity calculator 133 of the parameter selector 13 calculates the user similarity of the activity information set for each activity parameter extracted by the extractor 131 (step S16). In this example, in the activity information set for each activity parameter extracted by the extractor 131, the value of a last month and the value of the current month are compared with each other, and the number of other lower users (hereinafter, referred to as similar users) becoming close to the value of the target user is calculated as the user similarity. The user similarity is not limited to this example, and may be the number of other upper users becoming close to the target user, or a difference between the value of the activity parameter of the target user and the value of the activity parameter of another user.

In the example case illustrated in FIG. 8, there are five users within the extraction range from 10 to 20 (deliverables) of the “number of deliverables”, and there are two similar users. There are three users within the extraction range from 10 to 15 (kinds) of the “number of kinds of deliverables”, and there is one similar user. There are five users within the extraction range from JP 1000 to 2000 (YEN) of the “total set price of deliverables”, and there is one similar user. There is one user within the extraction range from JP 0 to 500 (YEN) of the “set price maximum value of deliverable”, and there is no similar user. There are two users within the extraction range from 10 to 20 (comments) of the “number of thanks comments”, and there is one similar user. The {rate} added to the number of similar users indicates a rate of the number of similar users relative to the number of other users than the target user ((number of similar users/number of other users in extraction range)×100 (%)). The selector 134 selects, as the presentation activity parameter, the activity parameter “number of deliverables” having the largest number of similar users among those activity parameters (step S17), and transmits the activity information set to the position calculator 14.

The condition of selecting the presentation activity parameter by the selector 134 is not limited to the one having the largest number of similar users. For example, such a condition may be one having the largest value of (number of similar users/number of other users in extraction range)×100 (%). In addition, when there are multiple candidates having the largest number of similar users, such a condition may be a combination with another condition such that the one having the larger value of (number of similar users/number of other users in extraction range)×100 (%).

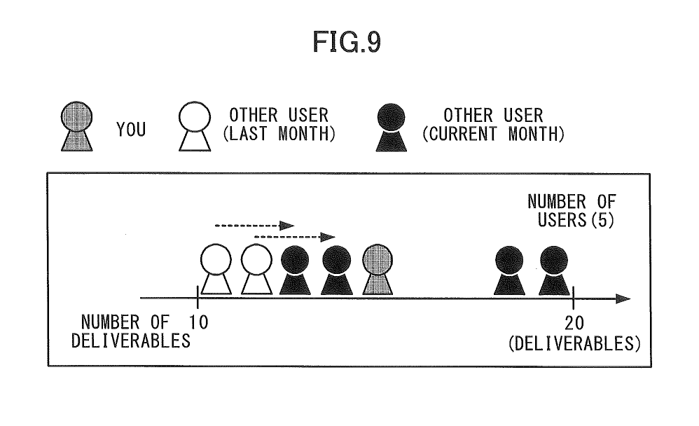

FIG. 9 is a diagram illustrating presentation information based on the user similarity by the action motivation system 100 illustrated in FIG. 1. The position calculator 14 calculates, with respect to the activity information set of the presentation activity parameter “number of deliverables” received from the selector 134, the position of the value of the “number of deliverables” of the target user relative to the value of the “number of deliverables” of other users. The position calculator 14 transmits positional information indicating the calculated position to the presentation information generator 15. The positional information is, for example, information obtained by associating information indicating the extraction range, the values of the presentation activity parameter of the activity information of the target user in the last month and in the current month, and the values of the presentation activity parameter of each activity information forming the activity information set in the last month and in the current month with each other. The presentation information generator 15 generates presentation information illustrated in FIG. 9 based on the positional information received from the position calculator 14.

In the example case illustrated in FIG. 9, the target user and other users within the extraction range from 10 to 20 (deliverables) of the presentation activity parameter “number of deliverables” are indicated by symbols and different colors. Hence, it becomes possible for the target user to understand the positional relationship with other users. In addition, how similar users become close to the target user from the last month to the current month is indicated by symbols in different colors and arrows of dashed lines. In this case, for example, a notification message to the effect that “two users become close to you since the last month” or “two users catch up with you with one deliverable and two deliverables, respectively”, may be added to the presentation information.

As explained above, according to the action motivation system 100 of this embodiment, the presentation activity parameter becomes selectable based on the predetermined condition on the distribution of the activity information set among multiple activity parameters. Hence, information on other users having similar activity level and accomplishment to the target user can be provided, thereby motivating the target user to take an action.

In the above-explained embodiment, the extractor 131 stores multiple activity parameters in advance. The present invention is, however, not limited to this case, and multiple calculating formulae may be applied to one activity parameter to generate multiple activity parameters, and those multiple activity parameters may be utilized. For example, with respect to an activity parameter, a new activity parameter that is a speed value may be generated based on the differential of a change in the activity quantity (for example, the number of deliverables) of each user within a certain time period. When the extractor 131 extracts the activity information set within a predetermined extraction range of the speed value, it becomes possible to present information on other users with a similar speed value to the target user. In addition, a goal value (for example, a user A has a goal for the number of deliverables in a current month which is 100 deliverables, and a user B has a goal for the number of deliverables in a current month which is 500 deliverables) may be set in advance with respect to one activity parameter, the current value of the activity parameter/goal value may be calculated, and a new activity parameter that is an accomplishment level to the goal may be generated.

The new activity parameter generated in this manner may be utilized in combination with the user density and the user similarity by the selector 134. When, for example, there are multiple activity parameters with the same user density, the activity parameter with a large speed of a user with a lower accomplishment is selected as the presentation activity parameter.

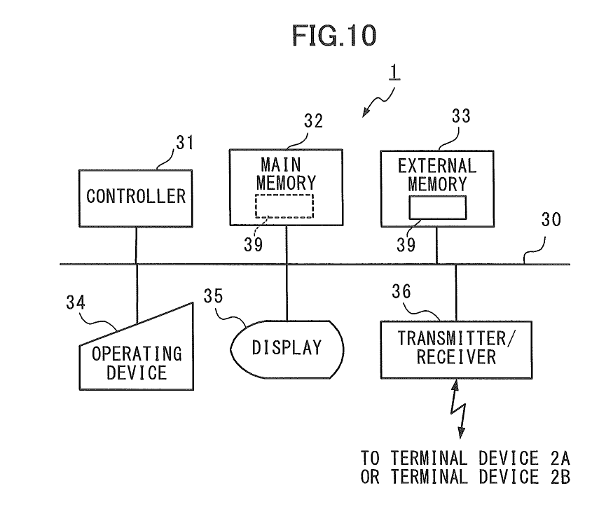

FIG. 10 is a diagram illustrating a hardware configuration of the action motivation device 1 illustrated in FIG. 1. As illustrated in FIG. 10, the action motivation device 1 includes a controller 31, a main memory 32, an external memory 33, an operating device 34, a display 35, and a transmitter/receiver 36. The main memory 32, the external memory 33, the operating device 34, the display 35, and the transmitter/receiver 36 are connected with the controller 31 via an internal bus 30.

The controller 31 includes a CPU (Central Processing Unit), and the like. In addition, the controller 31 executes respective processes in accordance with a control program 39 stored in the external memory 33. The controller 31 executes the respective processes by the parameter selector 13, the position calculator 14, and the presentation information generator 15.

The main memory 32 includes a RAM (Random Access Memory), and the like. In addition, the main memory 32 has the control program 39 loaded therein which is stored in the external memory 33. The controller 31 uses the external memory 33 as a work area.

The external memory 33 is a non-volatile memory, such as a flash memory, a hard disk, a DVD-RAM (Digital Versatile Disc Random-Access Memory), or a DVD-RW (Digital Versatile Disc ReWritable). In addition, the external memory 33 stores in advance the program for causing the controller 31 to execute the processes by the action motivation device 1. Alternatively, the external memory 33 supplies data stored with such a program to the controller 31 in accordance with an instruction from the controller 31. Next, the external memory 33 stores data supplied from the controller 31. The external memory 33 serves as the activity information memory 12.

The operating device 34 includes pointing devices like a keyboard and a mouse, and an interface device that connects the keyboard and the pointing device with the internal bus 30. When the user enters the activity parameter, and a predetermined period for extracting the activity information, the operating device 34 provides an instruction to the controller 31.

The display 35 includes a CRT (Cathode Ray Tube) or an LCD (Liquid Crystal Display), and the like. In addition, when the user enters the activity parameter and the predetermined period for extracting the activity information, the display 35 displays an operation screen. When the action motivation device 1 includes the outputter 22, the display 35 serves as the outputter 22.

The transmitter/receiver 36 includes a network terminal device or a wireless communication device connected with a communication network, and a serial interface or a LAN (Local Area Network) interface connected therewith. The activity information obtainer 11 and the presentation information generator 15 are connected with the communication network through the transmitter/receiver 36, and exchange information with the terminal device 2A or the terminal device 2B.

The processes by the activity information obtainer 11, the parameter selector 13, the position calculator 14, and the presentation information generator 15 illustrated in FIG. 1 are executed by the control program 39 that utilizes the controller 31, the main memory 32, the external memory 33, the operating device 34, the display 35, the transmitter/receiver 36, and the like as hardware resources.

Moreover, the above-explained hardware configurations and flowcharts are merely examples, which permit arbitrary changes and corrections. For example, although the action motivation system 100 of the above-explained embodiment includes the activity detector 21 and the outputter 22, the present invention is not limited to this case. The action motivation device 1 may have the activity detector 21 and/or the outputter 22.

The portion configured by the controller 31, the main memory 32, the external memory 33, the operating device 34, the internal bus 30, and the like executes the process of an action motivating operation. Such a portion is not limited to an exclusive system, but can be realized by a general computer system. For example, a computer program for executing the above-explained operations is stored in a computer-readable recording medium (for example, a flexible disk, a CD-ROM, or a DVD-ROM), and such a program is installed in a computer from the computer-readable recording medium. Accordingly, the action motivation system 100 executing the above-explained process can be configured. In addition, such a program may be stored in a memory device of the action motivation device 1 over a communication network like the Internet, and downloaded to a general computer system to configure the action motivation system 100.

Moreover, when the functions of the action motivation system 100 are shared by an OS (Operating System) and an application program, or are realized by a cooperative operation of the OS with the application program, only the application program portion may be stored in a recording medium or a memory device.

Still further, a computer program superimposed on carrier waves can be distributed over a communication network. For example, the computer program may be posted on a BBS (Bulletin Board System) over the communication network, and may be distributed over the communication network. Next, this computer program may be launched and executed under the control of the OS likewise other application programs to execute the above-explained processes.

A part of or all of the above-explained embodiment can be described as the following additional notations, but the present invention is not limited to the following additional notations.

(Additional Notation 1)

An action motivation device including:

an obtainer that obtains activity information indicating respective activities of a plurality of users;

a memory that stores the activity information obtained by the obtainer;

a selector that selects, based on the activity information stored in the memory, a parameter value within a predetermined range for each of a plurality of activity parameters which are barometers of the activity of the user, and selects a specific activity parameter based on a distribution of selected parameter values and a predetermined selection condition;

a position calculator that calculates a position of a target user relative to other users with respect to the specific activity parameter selected by the selector;

a generator that generates presentation information indicating the position of the target user; and

a presenter that presents the presentation information to the target user.

(Additional Notation 2)

The action motivation device as recited in additional notation 1, in which the selector calculates a user density indicating a variance in the parameter value of each activity parameter, and selects the specific activity parameter based on the user density.

(Additional Notation 3)

The action motivation device as recited in additional notation 1, in which the selector calculates a user similarity indicating a similarity level of a parameter value of the other users to a parameter value of the target user, and selects the specific activity parameter based on the user similarity.

(Additional Notation 4)

The action motivation device as recited in additional notation 1, in which the selector calculates a user density indicating a variance in the parameter value of each activity parameter, and a user similarity indicating a similarity level of a parameter value of the other users to a parameter value of the target user, and selects the specific activity parameter based on the user density and the user similarity.

(Additional Notation 5)

The action motivation device as recited in any one of additional notations 1 to 4, further including:

a parameter generator that generates a plurality of the parameter values by applying a plurality of calculating formulae to one of the activity parameters,

wherein the selector extracts, for each of the plurality of the parameter values generated by the parameter generator, an activity information set containing the activity parameter with a value within the predetermined range, and selects the specific activity parameter based on a predetermined condition for a distribution of values of each activity parameter of the extracted activity information set.

(Additional Notation 6)

The action motivation device as recited in any one of additional notations 1 to 5, in which the generator generates, as the presentation information, a display image for displaying the position, and/or a notification message for notifying of the position.

(Additional Notation 7)

The action motivation device as recited in any one of additional notations 1 to 6, further including an activity detection device that detects activity information indicating an activity of each of the plurality of users.

(Additional Notation 8)

An action motivation method that is executed by an action motivation device that motivates a target user to take an action, the method including:

an obtaining step of obtaining activity information indicating respective activities of a plurality of users;

a memory step of storing the activity information obtained through the obtaining step in a memory;

a selecting step of selecting, based on the activity information stored in the memory, a parameter value within a predetermined range for each of a plurality of activity parameters which are barometers of the activity of the user, and selecting a specific activity parameter based on a distribution of selected parameter values and a predetermined selection condition;

a position calculating step of calculating a position of the target user relative to the other users with respect to the specific activity parameter selected through the selecting step;

a generating step of generating presentation information indicating the position of the target user; and

a presenting step of presenting the presentation information to the target user.

(Additional Notation 9)

The action motivation method as recited in additional notation 8, in which in the selecting step, a user density indicating a variance in the parameter value of each activity parameter is calculated, and the specific activity parameter is selected based on the user density.

(Additional Notation 10)

The action motivation method as recited in additional notation 8, in which in the selecting step, a user similarity indicating a similarity level of a parameter value of the other users to a parameter value of the target user is calculated, and the specific activity parameter is selected based on the user similarity.

(Additional Notation 11)

The action motivation method as recited in additional notation 8, in which in the selecting step, a user density indicating a variance in the parameter value of each activity parameter, and a user similarity indicating a similarity level of a parameter value of the other users to a parameter value of the target user are calculated, and the specific activity parameter is calculated based on the user density and the user similarity.

(Additional Notation 12)

The action motivation method as recited in any one of additional notations 8 to 11, further including:

a parameter generating step of generating a plurality of the parameter values by applying a plurality of calculating formulae to one of the activity parameters,

in which in the selecting step, for each of the plurality of the parameter values generated by the parameter generator, an activity information set containing the activity parameter with a value within the predetermined range is extracted, and the specific activity parameter is selected based on a predetermined condition for a distribution of values of each activity parameter of the extracted activity information set.

(Additional Notation 13)

The action motivation method as recited in any one of additional notations 8 to 11, in which in the generating step, as the presentation information, a display image for displaying the position, and/or a notification message for notifying of the position is generated.

(Additional Notation 14)

The action motivation method as recited in any one of additional notations 8 to 11, further including a detecting step for detecting activity information indicating an activity of each of the plurality of users.

(Additional Notation 15)

A computer-readable recording medium having stored therein a program that causes a computer to function as:

an obtainer that obtains activity information indicating respective activities of a plurality of users;

a memory that stores the activity information obtained by the obtainer;

a selector that selects, based on the activity information stored in the memory, a parameter value within a predetermined range for each of a plurality of activity parameters which are barometers of the activity of the user, and selects a specific activity parameter based on a distribution of selected parameter values and a predetermined selection condition;

a position calculator that calculates a position of a target user relative to other users with respect to the specific activity parameter selected by the selector;

a generator that generates presentation information indicating the position of the target user; and

a presenter that presents the presentation information to the target user.

The above-explained embodiment is an exemplification of the specific embodiment of the present invention, and is not intended to limit the scope and spirit of the present invention. The present invention therefore permits various changes, modifications, and improvements freely within the scope and spirit of the present invention as recited in the appended claims.

The present invention claims the benefit of Japanese Patent Application No. 2011-153249 filed on Jul. 11, 2011. The entire specification, claims, and drawings of Japanese Patent Application No. 2011-153249 are herein incorporated in this specification by reference.

### REFERENCE SIGNS LIST

1 Action motivation device

2A, 2B Terminal device

11 Activity information obtainer

12 Activity information memory

13 Parameter selector

14 Position calculator

15 Presentation information generator

21 Activity detector

22 Outputter

31 Controller

32 Main memory

33 External memory

34 Operating device

33 Display

36 Transmitter/receiver

39 Control program

100 Action motivation system

131 Extractor

132 User density calculator

133 User similarity calculator

134 Selector

1. An action motivation device comprising:
an obtainer that obtains activity information indicating respective activities of a plurality of users;
a memory that stores the activity information obtained by the obtainer;
a selector that selects, based on the activity information stored in the memory, a parameter value within a predetermined range for each of a plurality of activity parameters which are barometers of the activity of the user, and selects a specific activity parameter based on a distribution of selected parameter values and a predetermined selection condition;
a position calculator that calculates a position of a target user relative to other users with respect to the specific activity parameter selected by the selector;
a generator that generates presentation information indicating the position of the target user; and
a presenter that presents the presentation information to the target user.

2. The action motivation device according to claim 1, wherein the selector calculates a user density indicating a variance in the parameter value of each activity parameter, and selects the specific activity parameter based on the user density.

3. The action motivation device according to claim 1, wherein the selector calculates a user similarity indicating a similarity level of a parameter value of the other users to a parameter value of the target user, and selects the specific activity parameter based on the user similarity.

4. The action motivation device according to claim 1, wherein the selector calculates a user density indicating a variance in the parameter value of each activity parameter, and a user similarity indicating a similarity level of a parameter value of the other users to a parameter value of the target user, and selects the specific activity parameter based on the user density and the user similarity.

5. The action motivation device according to claim 1, further comprising:
a parameter generator that generates a plurality of the parameter values by applying a plurality of calculating formulae to one of the activity parameters,
wherein the selector extracts, for each of the plurality of the parameter values generated by the parameter generator, an activity information set containing the activity parameter with a value within the predetermined range, and selects the specific activity parameter based on a predetermined condition for a distribution of values of each activity parameter of the extracted activity information set.

6. The action motivation device according to claim 1, wherein the generator generates, as the presentation information, a display image for displaying the position, and/or a notification message for notifying of the position.

7. The action motivation device according to claim 1, further comprising an activity detection device that detects activity information indicating an activity of each of the plurality of users.

8. An action motivation method that is executed by an action motivation device that motivates a target user to take an action, the method comprising:
an obtaining step of obtaining activity information indicating respective activities of a plurality of users;
a memory step of storing the activity information obtained through the obtaining step in a memory;
a selecting step of selecting, based on the activity information stored in the memory, a parameter value within a predetermined range for each of a plurality of activity parameters which are barometers of the activity of the user, and selecting a specific activity parameter based on a distribution of selected parameter values and a predetermined selection condition;
a position calculating step of calculating a position of the target user relative to other users with respect to the specific activity parameter selected through the selecting step;
a generating step of generating presentation information indicating the position of the target user; and
a presenting step of presenting the presentation information to the target user.

9. A computer-readable recording medium having stored therein a program that causes a computer to function as:
an obtainer that obtains activity information indicating respective activities of a plurality of users;
a memory that stores the activity information obtained by the obtainer;
a selector that selects, based on the activity information stored in the memory, a parameter value within a predetermined range for each of a plurality of activity parameters which are barometers of the activity of the user, and selects a specific activity parameter based on a distribution of selected parameter values and a predetermined selection condition;
a position calculator that calculates a position of a target user relative to other users with respect to the specific activity parameter selected by the selector;
a generator that generates presentation information indicating the position of the target user; and
a presenter that presents the presentation information to the target user.
